(19) United States
(12) Patent Application Publication
(10) Pub. No.: US 2014/0246458 A1
(43) Pub. Date: Sep. 4, 2014

(54) STACKABLE CONTAINER BODY

(71) Applicant: FUNDAMETAL DESIGNS INC., Burnaby (CA)

(72) Inventors: Blago LAKIC, Vancouver (CA); Evian MACMILLAN, Burnaby (CA)

(73) Assignee: FUNDAMETAL DESIGNS INC., Burnaby (CA)

(21) Appl. No.: 13/782,803

(22) Filed: Mar. 1, 2013

(51) Int. Cl. B67D 7/78; B65D 21/02

(52) U.S. Cl. CPC B67D 99/00; B65D 21/0217
USPC 222/143; 206/508; 29/428

(57) ABSTRACT

A fluid dispenser comprises a container body. The container body has a first end and a second end. The first end is larger in size than the second end. The container body is dimensioned such that the first end of the container body can be at least partially inserted into the second opening of another identical container body Container bodies may be nested for shipment to reduce volume and save on shipping costs. In some embodiments the first larger end of the container body has a squared off cross section, thereby allowing stacks of container bodies to be packaged together in a shipping container with reduced dead space.

### TECHNICAL FIELD

This application relates to stackable containers. An example embodiment provides a body that may be used in a dispenser to hold flowable materials such as sauces. Such dispensers have application, for example, in the food preparation industry.

### BACKGROUND

Containers are widely used for storing and dispensing fluids. For example, restaurants may use dispensing containers to dispense sauces and the like. Some such dispensers are portion-control dispensers that may be set to repeatably dispense set quantities of flowable materials.

As trade becomes more international, manufacturers are increasingly supplying worldwide markets from manufacturing facilities that may be located anywhere in the world. Shipping costs are becoming an important factor in the cost of supplying and obtaining products.

Most means of transporting cargo (e.g.: planes, trains, trucks, ships, etc.) have limitations on both the volume and the weight of the cargo they can transport in one load. For products that are relatively light in weight, such as empty containers, the shipping cost is determined primarily by the packed volume of the containers since empty containers typically have a high volume to weight ratio.

There is a need to reduce the cost of supplying containers.

### SUMMARY

This invention provides container bodies that have a configuration that facilitates densely packing the container bodies together for shipping. Shipping costs can be significantly reduced by fitting more container bodies into shipping containers of the same size and/or shipping the same number of container bodies in smaller shipping containers. Embodiments provide container bodies of the type that have openings at first and second opposed ends. Such container bodies may be used in dispensers of the type in which a flowable material is dispensed from an opening at one end of the container body while the container body can be refilled through an opening at the other end of the container body.

One aspect of the invention provides a fluid dispensing apparatus comprising a container body with a first opening at a first end of the container body and a second opening at a second end of the container body. The container body is dimensioned such that the second end of the container body can be at least partially inserted into the first opening of another identical container body.

In some embodiments, the container body is dimensioned such that the second end of the container body can be inserted a distance of at least half the length of the container body into the first opening of another identical container body.

In some embodiments, the container body is dimensioned such that the second end of a second identical container body can be inserted a distance of at least half of the length of the container body into the first opening of the container body.

In some embodiments, the radial cross sections of a first portion of the container body near the first end are generally rectangular in shape and the radial cross sections of a second portion of the container body near the second end are generally circular in shape.

In some embodiments, the radial cross sections of the first portion of the container body near the first end are generally square in shape. In some embodiments, the radial cross sections of the first portion of the container body near the first end have the shape of a square with cut off corners.

In some embodiments, the a fluid dispensing apparatus further comprises a first cap, the first cap operable to seal the first opening and a second cap, the second cap operable to seal the second opening.

In some embodiments, the second cap comprises a fluid dispensing cap.

In some embodiments, the second cap comprises a screw cap and a region of the container body adjacent to the second opening comprises threading wherein the screw cap is operable to interface with the threading to seal the second opening.

In some embodiments, the container body is made of one or more flexibly deformable materials.

Some embodiments comprise a shipping container in which a plurality of container bodies are packed. The container bodies are packed in a plurality of rows of stacked together container bodies. Each of the rows is adjacent to at least one other row. In some such embodiments the radial cross-section of the container bodies in their portions near the first end have flat faces and the flat faces of the container bodies in one of the rows are against the flat faces of the container bodies in the at least one adjoining row.

Another aspect of the invention provides a fluid dispenser comprising a chamber defined in part by a container body comprising a first part connected to and in fluid communication with a second part. The chamber has a first end and a second end. The second part of the chamber is sized to be received inside the first part of the chamber.

In another embodiment, the radial cross section of the first part of the chamber is square shaped and the second part is tubular.

In another embodiment, the second end of the chamber is narrower than the second part of the chamber.

In another embodiment, the first part is tapered away from the first end of the chamber.

In another embodiment, a bore of the chamber comprises one or more longitudinal grooves at the second end of the chamber.

In another related embodiment, the bore of the chamber comprises one or more longitudinal grooves at the first end of the chamber.

In another embodiment, the dispenser further comprises a nozzle coupled to and in fluid communication with the second end of the chamber.

In another related embodiment, the nozzle is supported on a cap at the second end of the chamber.

In a further related embodiment, the cap comprises a support surface extending past the nozzle in an axial direction.

In a further related embodiment, the dispenser further comprises a cover coupled to the first end.

In a further related embodiment, the cover comprises at least one aperture.

In a further related embodiment, a fluid dispensing mechanism is coupled to the cover.

Another embodiment of the invention provides a fluid dispenser comprising a chamber defined in part by a container body comprising a first part connected to and in fluid communication with a second part. The second part has substantially the same length as the first part. The chamber has a first end and a second end. The first end is bigger than the second end. The second part of the chamber is sized to be substantially received inside the first part of the chamber through the first opening. The first part is shaped to have a radial cross section of a square and the second part is tubular. The second part is narrower than the first part and the first part is tapered away from the first opening to meet the second part.

Another aspect of the current disclosure provides a method of stacking in a container a plurality of container bodies for use in fluid dispensers, each one of the plurality of container bodies having a first end and a second end. The first end is larger in size than the second end. The container bodies each comprise a first part connected to a second part. The first part includes the first end and the second part includes the second end. The second part of the container body is sized to be received inside the first part of the container body. The method comprises: nesting multiple ones of the plurality of chambers into each other such that for each two of the plurality of container bodies nested together, the second part of one of the two container bodies is received inside the first part of the other one of the two container bodies; and tightly stacking the coupled container bodies inside the shipping container to reduce unused space inside the shipping container.

Another aspect of the current disclosure provides a method of stacking in a shipping container a plurality of container bodies for use in fluid dispensers, each one of the plurality of container bodies having a first end and a second end. The first end is larger in size than the second end. The container body comprising a first part connected to a second part. The first part is coupled to the first end and the second part is coupled to the second end, wherein the second part of the container body is sized to fit substantially inside the first part of the container body. The method comprising: coupling multiple ones of the plurality of container bodies to each other such that for each two of the plurality of container bodies coupled to each other, the second part of one of the two container bodies substantially fits inside the first part of the other one of the two container bodies; and tightly stacking the coupled container bodies inside the shipping container to reduce unused space inside the shipping container.

Further aspects of the invention and features of example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a perspective view of a container body according to an example embodiment.

FIG. 2 is a side view of the container body of FIG. 1.

FIG. 3 is a perspective view of a dispense comprising a container body like that shown in FIG. 1 with covers and a dispensing nozzle attached.

FIG. 4 is another perspective view of the dispenser of FIG. 3 with a cap supporting the nozzle.

FIG. 5 is a side view of the dispenser of FIG. 4.

FIG. 6 is a cutaway view of the dispenser of FIG. 5.

FIG. 7 is a side view of four stacked container bodies.

FIG. 8 is a cutaway view of the stacked container bodies of FIG. 7.

FIG. 9 is a perspective view of multiple stacked container bodies as shown in FIG. 7 arranged side-by-side and on top of one other.

FIG. 10 is a top view of the stacked container bodies of FIG. 9 contained inside a container.

FIG. 11 is a side view of the stacked container bodies of FIG. 9 viewed from the large end of the container bodies.

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

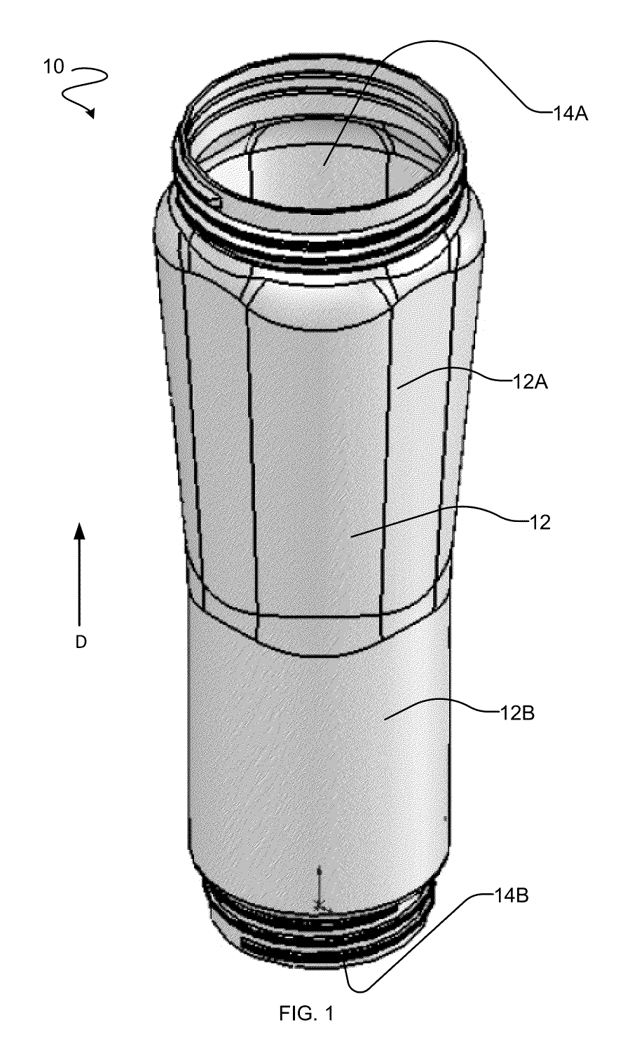

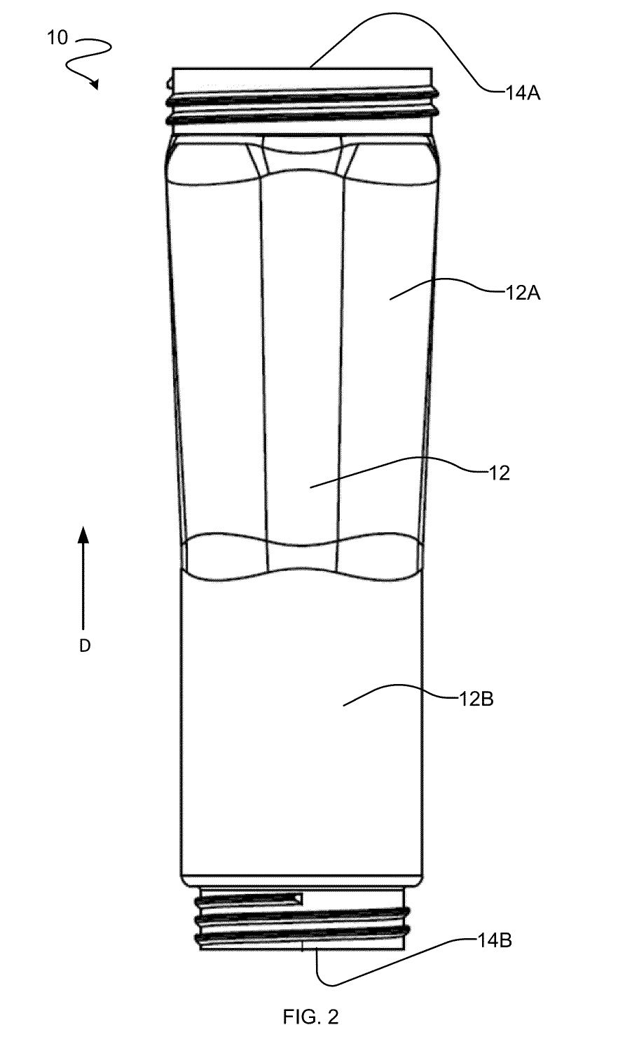

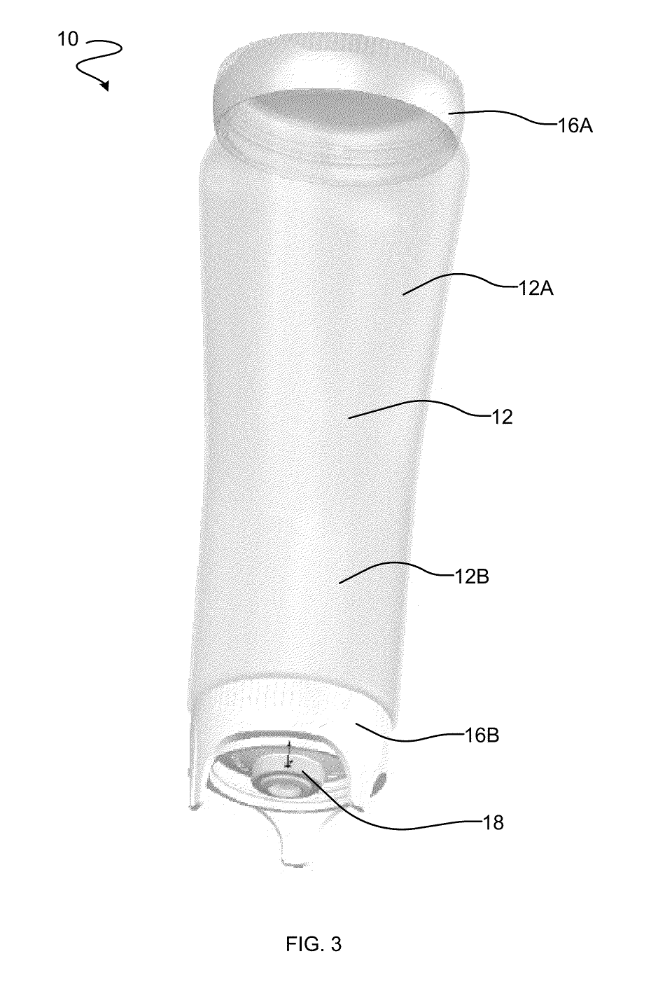

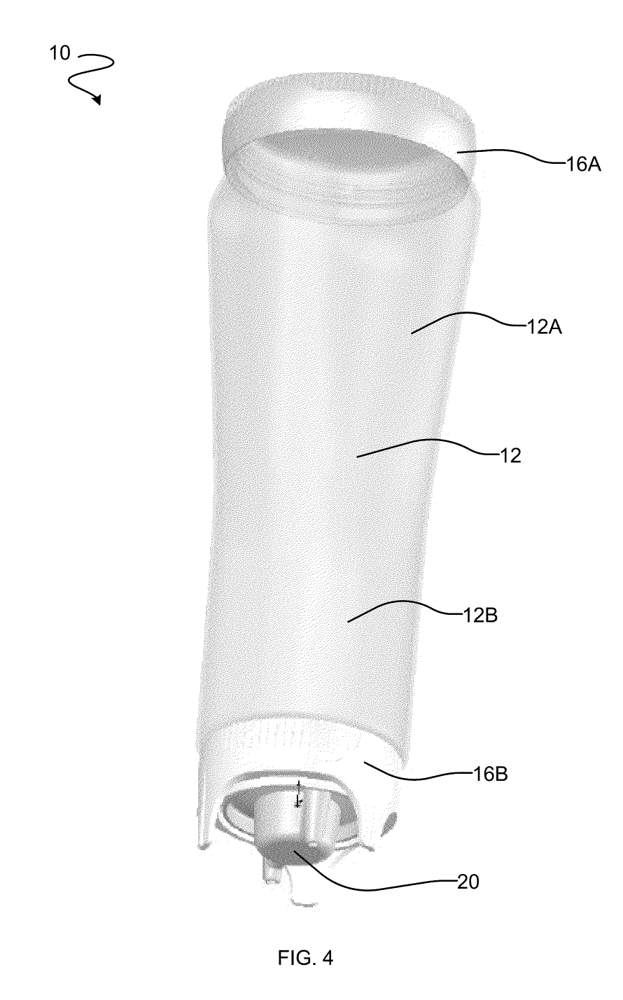

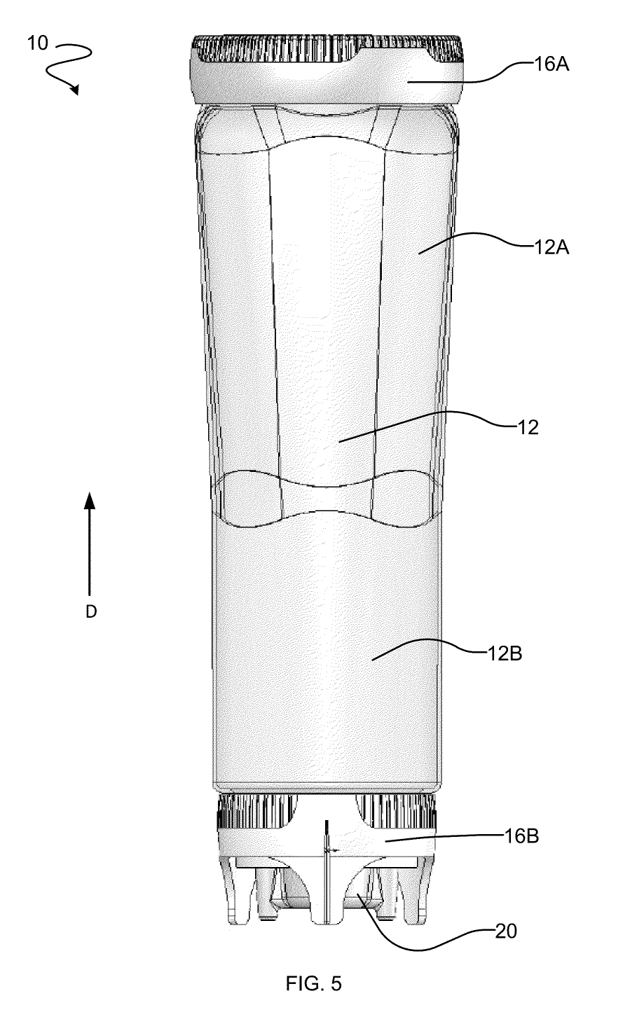

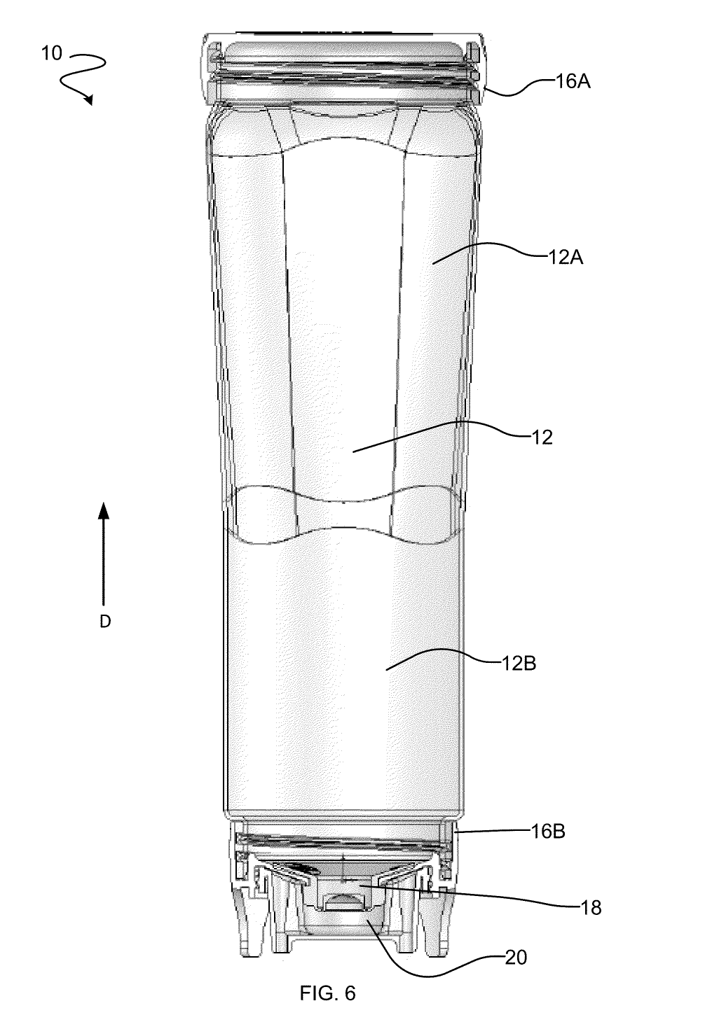

FIGS. 3 to 6 show a dispenser 10 according to an example embodiment. By way of non-limiting example, the parts of dispenser 10 may be made from materials such as suitable plastics. The parts of dispenser 10 may also or in the alternative be made from materials other than plastics. Dispenser 10 comprises a container body 12 comprising a first part 12A and a second part 12B. Container body 12 is illustrated in FIGS. 1 and 2. First part 12A and second part 12B are connected to each other and are in fluid communication. Container body 12 including first part 12A and second part 12B may be integrally-formed. First part 12A may be of the same length as second part 12B. First part 12A may also be larger or smaller in size than second part 12B.

Container body 12 has a first opening 14A and a second opening 14B. Openings 14A and 14B are at terminal ends of container body 12. Opening 14A is formed at an end of first part 12A. Opening 14B is formed at an end of second part 12B. In the illustrated embodiment, opening 14A is at an upper end of container body 12 and opening 14B is at a lower end of container body 12. In this embodiment when dispenser 10 is oriented for normal use, opening 14A is above opening 14B.

Upper opening 14A is closed by an upper closure 16A. In the illustrated embodiment upper closure 16A is removably coupled to container body 12 at upper opening 14A by screw threading. In other embodiments, upper closure 16A is removably coupled by other means. In some embodiments, when upper closure 16A is coupled to container body 12, it prevents a substance from exiting container body 12 via upper opening 14A. In some embodiments, upper closure 16A has a member which can be manipulated to either allow or prevent substances from exiting container body 12 via an aperture (not shown) in upper opening 14A (e.g.: an air release valve).

Lower opening 14B is closed by a lower closure 16B. In the illustrated embodiment lower closure 16B is removably coupled to container body 12 at lower opening 14B by screw threading. In other embodiments, lower closure 16B is removably coupled by other means. In some embodiments, when lower closure 16B is coupled to container body 12, it prevents a substance from exiting container body 12 via lower opening 14B. In some embodiments, lower closure 16B has a member which can be manipulated to either allow or prevent substances from exiting container body 12 via lower opening 14B.

In some embodiments, lower closure 16B includes a valve (not shown) which can allow or prevent a substance from exiting container body 12 depending on the difference between the pressure inside container body 12 and the pressure outside container body 12. In some embodiments, container body 12 is made of a flexibly deformable material, and container body 12 may be “squeezed” in order to increase the pressure therein and thereby force the contents of container body 12 to exit through lower opening 14B via the valve (not shown). In some embodiments, lower closure 16B incorporates a portion control dispensing mechanism.

First part 12A may be configured to have a cross-sectional shape that is same or different from the cross-sectional shape of second part 12B. By way of non-limiting example, either or both of first part 12A and second part 12B may be cylindrical having circular cross section taken on a planet perpendicular to direction D, or may have one or more defined edges forming cross sectional shapes such as squares, rectangles, triangles or other shapes taken on the same plane. In a preferred embodiment, first part 12A has flattened faces so that it is square with rounded or cut off corners in cross-section.

In some embodiments, the cross sections of container body 12, taken in the plane perpendicular to direction D, are circles. The diameters of the circular cross sections of upper portion 12A are larger than the diameters of the circular cross sections of the lower portion 12B. Thus a lower portion 12B of a first container body 12 can be inserted into an upper portion 12A of a second container body 12 through upper opening 14A. In some embodiments, such insertion requires removal of upper closure 16A and/or lower closure 16B.

Each of first and second parts 12A and 12B may also have a cross-sectional profile that is uniform or non-uniform. For example, first part 12A may have the same cross sectional area taken in a plane perpendicular to direction D at different points along its length. Alternatively, first part 12A may be tapered away from opening 14A such that the cross sectional area taken near second part 12B is smaller than the cross sectional area taken near opening 14A. First part 12A and second part 12B may also have a non-cylindrical shape with rounded edges. Independent of the shape of first part 12A and second part 12B, first part 12A is sized to be larger than second part 12B such that second part 12B may fit through opening 14A to be received entirely or substantially within first part 12A.

FIGS. 1 and 2 show opening 14A being smaller in size and different in shape from first part 12A. In some embodiments, opening 14A may be of the same size and/or shape as first part 12A. Similarly, opening 14B may be of the same or different size and/or shape as second part 12B.

In cases where closure 16A and/or closure 16B attach to container body 12 by a connection means such as snapping on that do not require them to be round then opening 14A and/or 14B may have non-round shapes. Opening 14A and 14B may have the same shapes or different shapes. For example, opening 14A may be square and opening 14B may be round. All that is required is that opening 14A is sized to have large enough inner dimensions that opening 14B and second part 12B can pass through opening 14A to be entirely or substantially received in part 12A.

Openings 14A may bear screw threads for attaching removable cover 16A (see FIG. 3). Cover 16A may be removably attached to opening 14A by other means. For instance, by way of non-limiting example, cover 16A may be attached to opening 14A by way of a clipping mechanism, a snap fit, or the like.

Similarly, opening 14B may bear screw threads for attaching removable cover 16B (see FIG. 3). Cover 16B may be removably attached to opening 14B by other means. For instance, by way of non-limiting example, cover 16B may be attached to opening 14B by way of a clipping mechanism, a snap fit or the like. In some embodiments, cover 16B may be permanently affixed to opening 14A.

Covers 16A and 16B may be made from the same material as container body 12 or may be made from other materials.

FIGS. 3-6 show a fluid measuring mechanism or a nozzle 18 coupled to cover 16B. Nozzle 18 may be used for measuring a pre-determined amount of fluid to be dispensed from container body 12 through opening 14B. In some embodiments, nozzle 18 may be coupled to an adapter 20. Adapter 20 may be used to couple container body 12 to nozzles (not shown) having different configuration from nozzle 18.

The features of container body 12, specifically the relationship between first part 12A, second part 12B and openings 14A and 14B may allow for stacking a plurality of container bodies 10 and loading them into a shipping container such that the total volume occupied by the stacked container bodies is significantly less than the total volume of the container bodies packed individually in the same container. This may allow loading more container bodies inside one shipping container and reducing the overall associated shipping costs in cases where the shipping costs for such container bodies is determined primarily by the dimensions of the shipping container in which the container bodies are shipped.

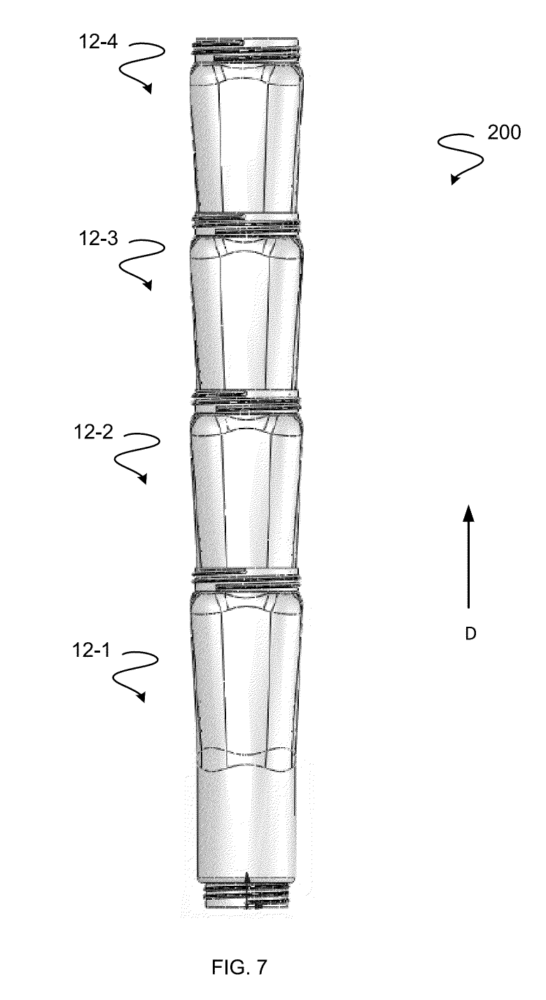

FIG. 7 is a side view of container bodies 12 stacked together: container body 12-1, container body 12-2, container body 12-3, and container body 12-4. The four container bodies are stacked in a stack 200 such that: part of container body 12-2 fits into container body 12-1, part of container body 12-3 fits into container body 12-2, and part of container body 12-4 fits into container body 12-3. The total volume required to enclose stack 200 is less than the sum of the volume of the four container bodies 12 unstacked. More container bodies 12 may be added to stack 200 to form a longer stack.

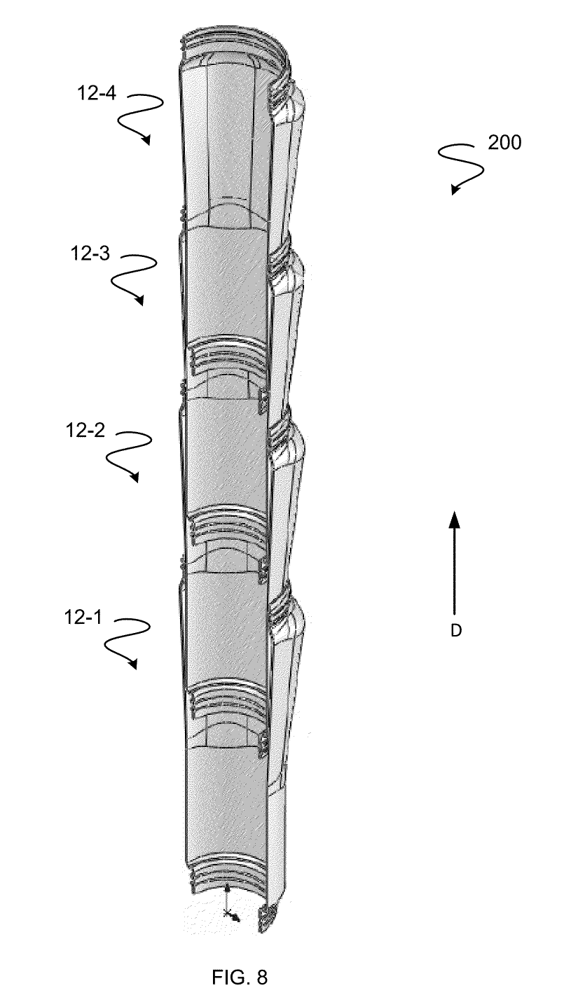

FIG. 8 is a cutaway view of the stacked container bodies of FIG. 7.

Stacks 200 may be formed while cover 16B is coupled to opening 14B for each container body 12 in the stack 200. Stacks 200 may also be formed where covers 16A and 16B for each container body 12 are removed. Covers 16A and 16 B as well as other components of dispenser 10 may be packaged and shipped independently from stackable container bodies 12.

The straight sides of the squared off portion of container body 12 may enhance packing efficiency. The straight sides may lie flush with the walls of a shipping container and with the straight sides of other container bodies, thereby reducing the amount of “dead space” within the shipping container.

The straight sides of the squared off portion of container body 12 may also prevent container body 12 (or a stack of such container bodies) from rolling about its longitudinal axis.

In other embodiments, container body 12 has other shapes. In some embodiments, the relationship between the dimensions of upper portion 12A and the dimensions of lower portion 12B are such that only some of lower portion 12B of a first container body 12 can be inserted into upper portion 12A of a second container body 12. In some embodiments, container body 12 is made out of a flexibly deformable material, and insertion of lower portion 12B into upper portion 12A causes container body 12 to deform. In some embodiments, the flexibly deformable material is medium-density polyethylene (MDPE).

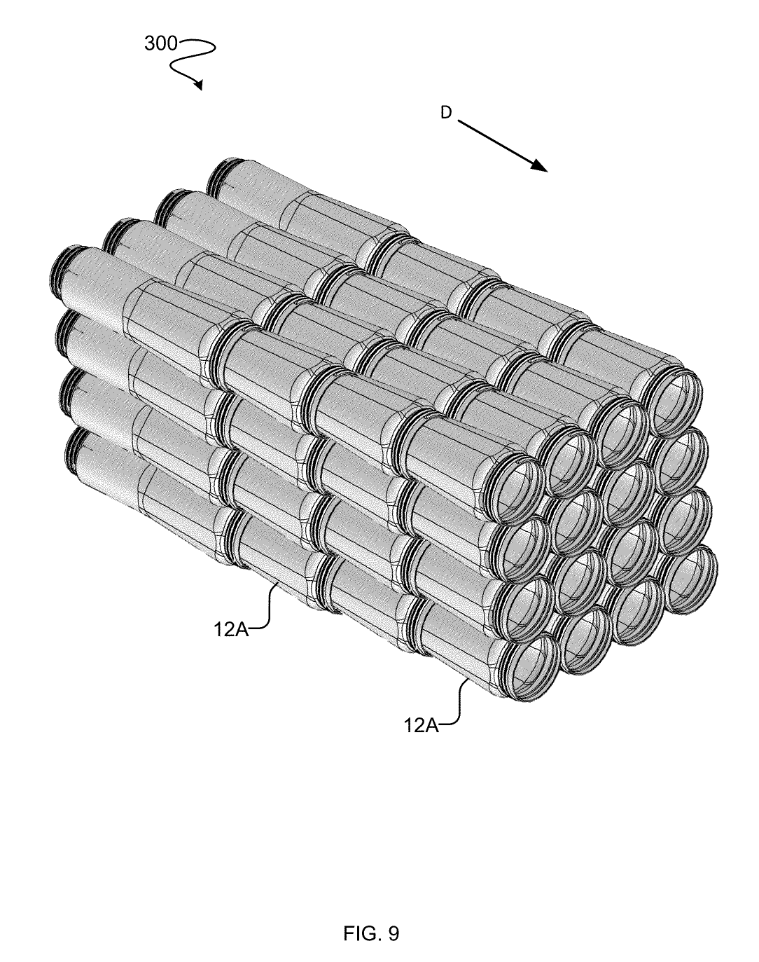

A plurality of container bodies 12 may be combined to form a plurality of stacks. FIG. 9 shows a perspective view of a plurality of container bodies 12 having upper portions 12A configured to have flattened sides and rounded corners, where the plurality of container bodies 12 are stacked side-by-side and on top of one another, with all the container bodies 12 having the same orientation, to form stack 300.

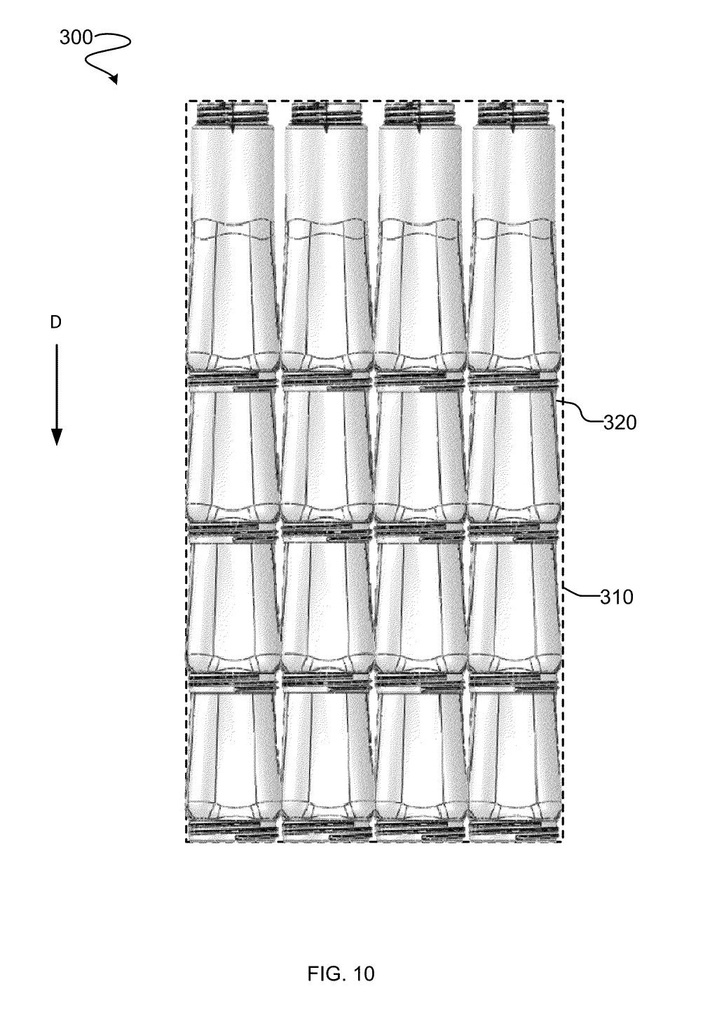

FIG. 10 shows a top view of stack 300 in a container 310 represented by a dashed line. FIG. 10 shows that when stacking container bodies 12 inside container 310, the flattened sides of portions 12A of container bodies 12 significantly reduces unused space 320 between container bodies 12 and container 310.

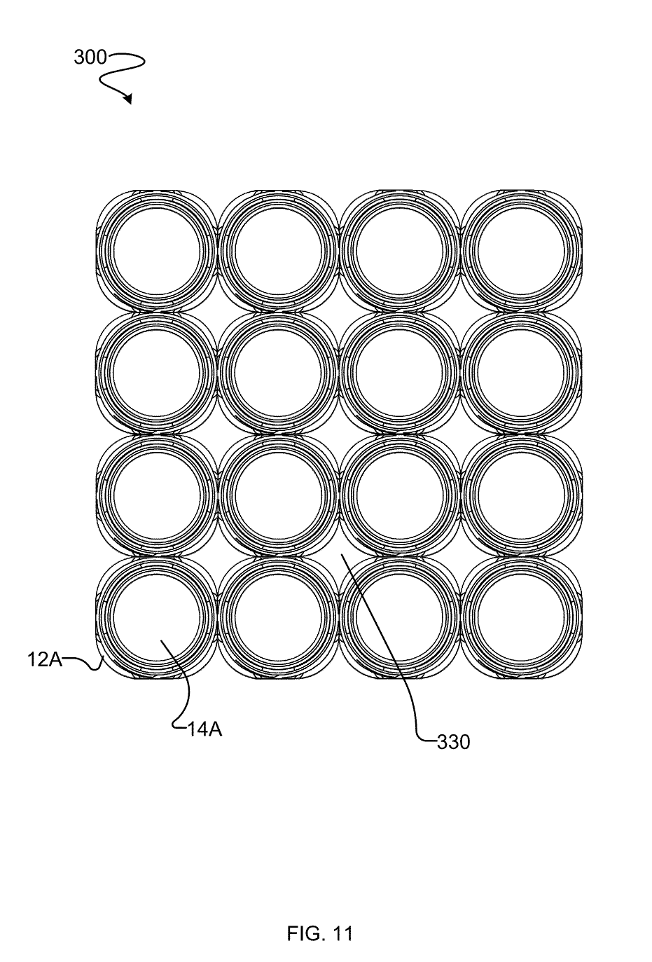

FIG. 11 shows a side view of stack 300 looking at openings 14A near first ends 12A of container bodies 12. In FIG. 11, the flattened sides of portions 12A of container bodies 12 reduce the unused space 330 between container bodies 12 when stacked next to and on top of one another. In some embodiments, unused space 330 may further be reduced by configuring container bodies 12 to have corners with other shapes to help occupy more of unused space 330. For example, container bodies 12 may be configured to have squared off corners instead of rounded corner.

More container bodies 12 may be added to stack 300 to increase the size of the stack. Stacks 300 may be transported relatively efficiently compared to unstacked container bodies. The total volume of N container bodies, each of volume V, is N×V. The volume of the N container bodies in a stacked configuration is less than N×V. This reduced volume permits a greater number of container bodies to fit within a given shipping container (or any other means of transporting container bodies).

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### Interpretation of Terms

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a,” “an,” and “the” also include the meaning of any appropriate plural forms.

Words that indicate directions such as “vertical,” “transverse,” “horizontal,” “upward,” “downward,” “forward,” “backward,” “inward,” “outward,” “vertical,” “transverse,” “left,” “right,” “front,” “back” ,” “top,” “bottom,” “below,” “above,” “under,” and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. an upper closure, lower closure, valve, container body, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A container body for use in a fluid dispensing apparatus, the container body comprising a first opening at a first end of the container body and a second opening at a second end of the container body, wherein the container body is dimensioned such that the second end of the container body can be at least partially inserted into the first opening of another identical container body.

2. A container body according to claim 1 wherein the container body is dimensioned such that the second end of the container body can be inserted a distance of at least half the length of the container body into the first opening of the identical container body.

3. A container body according to claim 2 wherein the container body is dimensioned such that the second end of a further identical container body can be inserted a distance of at least half of the length of the container body into the first opening of the container body.

4. A container body according to claim 1 wherein radial cross sections of a first portion of the container body near the first end are generally rectangular in shape and radial cross sections of a second portion of the container body near the second end are generally circular in shape.

5. A container body according to claim 4 wherein one of the radial cross sections of the first portion of the container body is a generally rectangular shape with a width W and a height H and the container body is dimensioned to fit inside a rectangular box of dimensions W by H by the length of the container body.

6. A container body according to claim 4 wherein the radial cross sections of the first portion of the container body near the first end are generally square in shape.

7. A container body according to claim 4 wherein the radial cross sections of the first portion of the container body near the first end has flattened sides and rounded or cut off corners.

8. A container body according to claim 1 further comprising a first cap, the first cap operable to seal the first opening and a second cap, the second cap operable to seal the second opening.

9. A container body according to claim 8 wherein the second cap comprises a fluid dispensing cap.

10. A container body according to claim 8 wherein the second cap comprises a screw cap and a region of the container body adjacent to the second opening comprises threading wherein the screw cap is operable to interface with the threading to seal the second opening.

11. A container body according to claim 1 wherein the container body is made of flexibly deformable material.

12. A method for reducing the aggregate volume occupied by a first fluid dispensing apparatus and a second fluid dispensing apparatus, the method comprising stacking the first and second fluid dispensing apparatuses, wherein:
each of the first and the second fluid dispensing apparatuses comprise a container body, the container body comprising a first opening at a first end of the container body and a second opening at a second end of the container body, wherein the container body is dimensioned such that the second end of the container body can be at least partially inserted into the first opening of a first identical copy of the container body; and
stacking the first and second fluid dispensing apparatuses comprises partially inserting the first fluid dispensing apparatus into the second fluid dispensing apparatus.

13. A method according to claim 12 for reducing the aggregate volume occupied by a plurality of fluid dispensing apparatuses, the method comprising iteratively repeating the method of claim 12 to assemble the plurality of fluid dispensing apparatuses into a single stack.

14. A fluid dispenser comprising a chamber, the chamber having a first end and a second end, the first end larger in size than the second end; the chamber comprising a first part connected to a second part, the first part and the second part in fluid communication, the first part coupled to the first end and the second part coupled to the second end;
wherein the second part of the chamber is sized to fit entirely inside the first part of the chamber.

15. A dispenser according to claim 14, wherein a radial cross section of the first part of the chamber is square shaped and a radial cross section of the second part is tubular.

16. A dispenser according to claim 15, wherein the second end of the chamber is narrower than the second part of the chamber.

17. A dispenser according to claim 16, wherein the first part is tapered away from the first end of the chamber.

18. A dispenser according to claim 14, wherein a bore of the chamber comprises one or more longitudinal grooves at the second end of the chamber.

19. A dispenser according to claim 18, wherein the bore of the chamber comprises one or more longitudinal grooves at the first end of the chamber.

20. A dispenser according to claim 14 further comprising a nozzle coupled to and is in fluid communication with the second end of the chamber.

21. A dispenser according to claim 20, wherein the nozzle is supported on a cap at the second end of the chamber.

22. A dispenser according to claim 21, wherein the cap comprises a support surface extending past the nozzle in an axial direction.

23. A dispenser according to claim 22 further comprising a cover coupled to the first end.

24. A dispenser according to claim 23, wherein the cover comprises at least one aperture.

25. A dispenser according to claim 24, wherein a fluid pushing mechanism is coupled to the cover.

26. A fluid dispenser comprising a chamber, the chamber having a first end and a second end, the first end larger in size than the second end; the chamber comprising a first part connected to a second part, the first part and the second part in fluid communication, the first part coupled to the first end and the second part coupled to the second end;
wherein the second part of the chamber is sized to fit substantially inside the first part of the chamber.

27. A method of stacking in a container a plurality of chambers for use in fluid dispensers, each one of the plurality of chambers having a first end and a second end, the first end larger in size than the second end; the chamber comprising a first part connected to a second part, the first part coupled to the first end and the second part coupled to the second end wherein the second part of the chamber is sized to fit entirely inside the first part of the chamber, the method comprising:
coupling multiple ones of the plurality of chambers to each other such that for each two of the plurality of chambers coupled to each other, the second part of one of the two chambers fits inside the first part of the other one of the two chambers; and
tightly stacking the coupled chambers inside the container to reduce unused space inside the container.

28. A method according to claim 27, wherein for each of the plurality of chambers a radial cross section of the first part of the chamber is square shaped and a radial cross section of the second part of the chamber is tubular.

29. A method according to claim 27, wherein for each of the plurality of chambers a radial cross section of the first part of the chamber has flattened sides and rounded or cut off corners and a radial cross section of the second part of the chamber is tubular.

30. A method according to claim 29, wherein for each of the plurality of chambers the second end of the chamber is narrower than the second part of the chamber.

31. A method according to claim 30, wherein for each of the plurality of chambers the first part of the chamber is tapered away from the first end of the chamber.

32. A method according to claim 31, wherein for each of the plurality of chambers a bore of the chamber comprises one or more longitudinal grooves at the second end of the chamber.

33. A method according to claim 32, wherein for each of the plurality of chambers the bore of the chamber comprises one or more longitudinal grooves at the first end of the chamber.

34. A method of stacking in a container a plurality of chambers for use in fluid dispensers, each one of the plurality of chambers having a first end and a second end, the first end larger in size than the second end; the chamber comprising a first part connected to a second part, the first part coupled to the first end and the second part coupled to the second end wherein the second part of the chamber is sized to fit substantially inside the first part of the chamber, the method comprising:
coupling multiple ones of the plurality of chambers to each other such that for each two of the plurality of chambers coupled to each other, the second part of one of the two chambers substantially fits inside the first part of the other one of the two chambers; and
tightly stacking the coupled chambers inside the container to reduce unused space inside the container.
